(19) United States
(12) Patent Application Publication
(10) Pub. No.: US 2026/0359241 A1
(43) Pub. Date: Nov. 12, 2026

(54) MICROCONTROLLER UNIT SYSTEM WITH CHANNEL CONFIGURATION CHECK

(71) Applicant: Monolithic Power Systems, Inc., Kirkland, WA (US)

(72) Inventor: Régis Caillet, Bevaix (CH)

(21) Appl. No.: 19/202,977

(22) Filed: May 8, 2025

(51) Int. Cl. G06F 13/28

(52) U.S. Cl. CPC G06F 13/28; G06F 2213/28

(57) ABSTRACT

A microcontroller unit system having a direct memory access unit with a check unit is discussed. The check unit checks the consistency of a configuration of an applied channel to the DMA and a configuration of a corresponding region register if any of the applied channel or the region register is updated, to authorize or reject a transfer based on the check result. If the channel is authorized, the transfer is initiated.

### BACKGROUND OF THE INVENTION

A MCU system is commonly composed of one or more processors and optionally one or more direct-memory-access (DMA) modules. The DMA typically refers to a data transition via a bus from a peripheral device to a main memory without executing a program using a central processing unit (CPU). Thus, the DMA highly increases the data input/output speed and reduces the speed difference between the CPU and the peripheral device. If the input/output device requests a DMA, the CPU hands over the control of the main memory.

A memory protection unit (MPU) is usually present in the bus to filter who can access which memories. This MPU checks the address and the attributes of all transfers. However, frequently check adds logic in the address path which reduces the maximum frequency reachable by the product for a given technology and voltage level.

### SUMMARY OF THE INVENTION

In accordance with an embodiment of the present invention, a microcontroller unit is discussed. The microcontroller unit comprises: a DMA unit, configured to control a transfer between a peripheral device and a memory via a bus in response to a trigger. The DMA unit comprises: N region registers and a check unit. Each region register corresponds to a respective channel applied to the DMA unit. N is an integer larger than 1. The check unit is configured to check whether a configuration of an applied channel is conformed to a rule if any of the applied channel or the region register is updated, to authorize or reject the transfer based on a check result.

In addition, in accordance with an embodiment of the present invention, a microcontroller unit is discussed. The microcontroller unit comprises: a processor and a DMA unit. The DMA unit is configured to control a transfer in response to a trigger for direct memory access. The DMA unit comprises: N region registers, each corresponding to a respective channel applied to the DMA unit. N is an integer larger than 1. The DMA unit is configured to check whether a configuration of an applied channel is conformed to a rule if any of the applied channel or the region register is updated, to authorize or reject the transfer based on a check result.

Furthermore, in accordance with an embodiment of the present invention, a direct memory access method is discussed. The method comprises: a DMA unit checking whether a channel configuration is conformed to a rule in response to an update of the channel configuration or an update of a region configuration; receiving a trigger for direct memory access from an input/output device; and detecting whether the DMA checking is ongoing: ignoring the trigger until the DMA checking is completed if the DMA checking is ongoing; and initiating or denying a transfer based on a check result if the DMA checking is completed.

### BRIEF DESCRIPTION OF DRAWINGS

FIG. 1 schematically shows a microcontroller unit system 100 in accordance with an embodiment of the present invention.

FIG. 2 schematically shows a microcontroller unit system 200 with a circuit configuration of the check unit 11 in accordance with an embodiment of the present invention.

FIG. 3 schematically shows a microcontroller unit system 300 in accordance with an embodiment of the present invention.

FIG. 4 schematically shows a flowchart 400 of a direct memory access method in accordance with an embodiment of the present invention.

### DETAILED DESCRIPTION OF THE INVENTION

Embodiments of circuits for microcontroller unit system are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

FIG. 1 schematically shows a microcontroller unit system 100 in accordance with an embodiment of the present invention. In the example of FIG. 1, the microcontroller unit system 100 comprises: a direct-memory-access (DMA) unit 101 and at least one memory 102. The DMA unit 101 is configured to control a transfer (e.g. data) between 1) a peripheral device 103 and a memory 102 via a bus 110, or 2) different periphery devices 103 (e.g., from one periphery device 103 to the other periphery device 103), or 3) different memories (e.g. from one memory 102 to the other memory 102) in response to a trigger (e.g. a DMA request).

In one embodiment of the present invention, the trigger may be a hardware trigger from an input/output device such as the periphery device, or a software trigger from such as a processor (e.g., a CPU). The DMA unit 101 comprises N region registers (R1, R2, . . . , and RN). N is an integer larger than 1. The N region registers each corresponds to a respective channel applied to the DMA unit 101. That is, the DMA unit 101 may have N channels applied thereto, each channel corresponding to a region register. The DMA unit 101 further comprises: a check unit 11 and a transfer unit 12. The check unit 11 is configured to check whether a configuration of the applied channel is conformed to a rule (or a limitation) if any of the applied channel or the region register is updated, to authorize or reject the transfer based on a check result. The transfer unit 12 is configured to initiate the transfer if the applied channel is authorized.

In one embodiment of the present invention, the rule may comprise a consistency of the configuration of the applied channel and the configuration of the corresponding region register. If the configuration of the applied channel violates the rule (e.g., there is an inconsistency between the configuration of the applied channel and the configuration of the corresponding region register), the check unit 11 would deny the request, and no transfer would be started via the DMA unit 101. If the configuration of the applied channel meets the rule (e.g., the configuration of the applied channel is conform to the configuration of the corresponding region register), the transfer would be initiated.

In one embodiment of the present invention, the “unit” may refer to a software element configured to be executed by a hardware element such as a process, or refer to a hardware element, such as a Field Programmable Gate Array (FPGA) or an Application Specific Integrated Circuit (ASIC) performing a predetermined function. However, one skilled in the art should realize that the unit does not always have a meaning limited to software or hardware.

In one embodiment of the present invention, the channel may be applied from the periphery device 103 or from the memory 102, either one is via the bus 110.

In one embodiment of the present invention, the DMA unit 101 is able to receive (read) data from the periphery devices 103 and send (write) data to the periphery devices 103. The DMA unit 101 is also able to receive (read) data from the memories 102 and send (write) data to the memories 102.

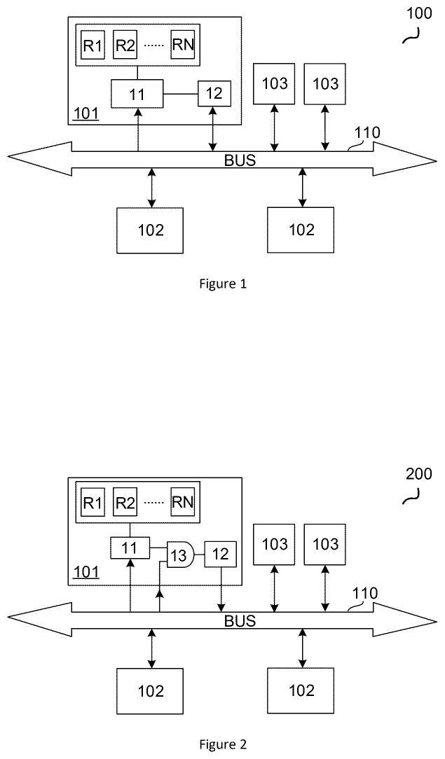

FIG. 2 schematically shows a microcontroller unit system 200 in accordance with an embodiment of the present invention. In the example of FIG. 2, the check unit 11 comprises: a state machine, configured to go over the applied channels in series (i.e., one by one), to check the consistency of the configurations of the applied channels and the corresponding region registers when any of the applied channel or the region register is updated. When the check unit 11 is checking, no transfer is started. That is, no transfer is started until the state machine completes the verification. When the state machine 13 completes the verification, and the check result turns out that the configuration of the applied channel meets the rule, the check unit 11 will gate the request (e.g. the trigger) received at the transfer unit 12, to initiate the transfer. As shown in FIG. 2, the DMA unit 101 further comprises a logical AND unit 13, electrically set between the check unit 11 and the transfer unit 12, to gate or not gate the request.

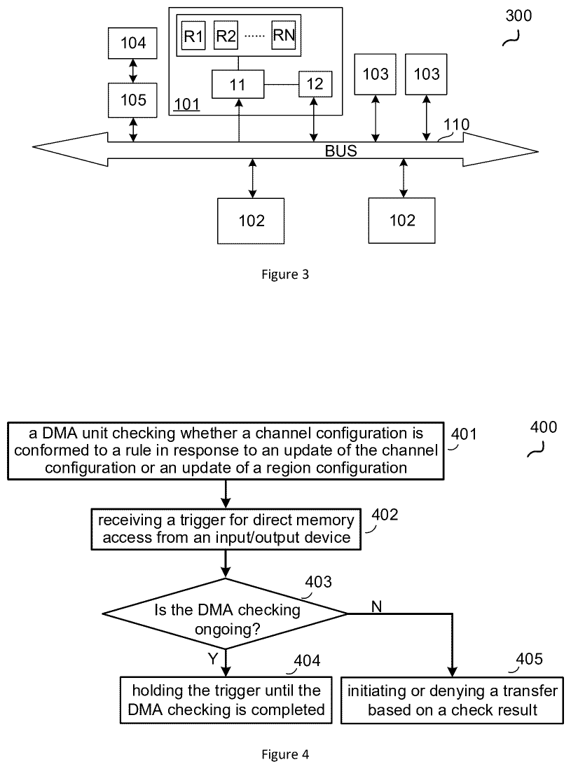

FIG. 3 schematically shows a microcontroller unit system 300 in accordance with an embodiment of the present invention. The microcontroller unit system 300 is similar to the microcontroller system 100 in FIG. 1, with a difference that, in the example of FIG. 3, the microcontroller system 300 further comprises: a processor (e.g., a CPU) 104 and a cache 105. The processor 104 is configured to control a transfer between 1) the cache 105 and the memories 102, 2) the cache 105 and the periphery devices 103, and 3) the memories 102 and the periphery devices 103. If an input/output device requests direct memory access, the processor 104 is configured to hand over the control, and the DMA unit 101 starts to work as discussed hereinbefore. If the check result of the check unit 11 indicates that there is an inconsistency between the configuration of the applied channel and the configuration of the corresponding region register, e.g., the configuration of the applied channel violates the rule, the DMA unit 101 would notice the processor 104. The processor 104 would take necessary actions in response to the configuration issue.

FIG. 4 schematically shows a flowchart 400 of a direct memory access method in accordance with an embodiment of the present invention. The method comprises:

Step 401, a DMA unit checking whether a channel configuration is conformed to a rule in response to an update of the channel configuration or an update of a region configuration. In one embodiment of the present invention, the rule may refer to a consistency of the channel configuration and the region configuration. The channel configuration may refer to a configuration of an applied channel; and the region configuration may refer to a configuration of a region register in the DMA unit.

Step 402, receiving a trigger (i.e., request) for direct memory access from an input/output device.

Step 403, detecting whether the DMA checking is ongoing, if the DMA checking is ongoing, going to step 404; else, going to step 405.

Step 404, ignoring the trigger until the DMA checking is completed.

Step 405, initiating or denying a transfer based on a check result. If the channel configuration is conformed to the rule, the transfer would be initiated; and if the channel configuration violates the rule, the trigger is ignored and the transfer would be denied.

In one embodiment of the present invention, the method further comprises: checking the channel configurations in series.

In one embodiment of the present invention, the method further comprises: noticing a processor (e.g., a CPU) if the configuration of the applied channel violates the rule.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

1. A microcontroller unit, comprising:
a DMA unit, configured to control a transfer between a peripheral device and a memory via a bus in response to a trigger; wherein the DMA unit comprises:
N region registers, each corresponding to a respective channel applied to the DMA unit, wherein N is an integer larger than 1; and
a check unit, configured to check whether a configuration of an applied channel is conformed to a rule if any of the applied channel or the region register is updated, to authorize or reject the transfer based on a check result.

2. The microcontroller unit of claim 1, wherein the DMA unit further comprises:
a transfer unit, configured to initiate the transfer if the applied channel is authorized.

3. The microcontroller unit of claim 1, wherein the rule comprises:
a consistency of the configuration of the applied channel and the configuration of the corresponding region register.

4. The microcontroller unit of claim 1, wherein:
if the configuration of the applied channel violates the rule, no transfer is started via the DMA unit; and
if the configuration of the applied channel meets the rule, the transfer is initiated.

5. The microcontroller unit of claim 1, wherein:
the channel is applied from the periphery device or from the memory.

6. The microcontroller unit of claim 1, wherein the trigger comprises:
a hardware trigger from an input/output device; or
a software trigger.

7. The microcontroller unit of claim 1, wherein the check unit comprises:
a state machine, configured to go over all of the applied channels one by one, to check whether all of the applied channels are conformed to the rule.

8. The microcontroller unit of claim 7, wherein:
no transfer is started until the stage machine completes checking all of the applied channels.

9. A microcontroller unit, comprising:
a processor; and
a DMA unit, configured to control a transfer in response to a trigger for direct memory access; wherein the DMA unit comprises:
N region registers, each corresponding to a respective channel applied to the DMA unit, wherein N is an integer larger than 1, and wherein the DMA unit is configured to check whether a configuration of an applied channel is conformed to a rule if any of the applied channel or the region register is updated, to authorize or reject the transfer based on a check result.

10. The microcontroller unit of claim 9, wherein the DMA unit further comprises:
a check unit, configured to check whether the configuration of the applied channel is conformed to the rule if any of the applied channel or the region register is updated; and
a transfer unit, configured to initiate the transfer if the applied channel is authorized.

11. The microcontroller unit of claim 10, wherein the check unit comprises:
a state machine, configured to go over all of the applied channels one by one, to check whether all of the applied channels are conformed to the rule.

12. The microcontroller unit of claim 11, wherein:
no transfer is started until the stage machine completes checking all of the applied channels.

13. The microcontroller unit of claim 9, wherein the rule comprises:
a consistency of the configuration of the applied channel and the configuration of the corresponding region register.

14. The microcontroller unit of claim 9, wherein:
if the configuration of the applied channel violates the rule, no transfer is started via the DMA unit; and
if the configuration of the applied channel meets the rule, the transfer is initiated.

15. The microcontroller unit of claim 9, wherein:
the channel is applied from a periphery device or from a memory, either one is via a bus.

16. The microcontroller unit of claim 9, wherein the trigger comprises:
a hardware trigger from an input/output device; or
a software trigger.

17. A direct memory access method, comprising:
a DMA unit checking whether a channel configuration is conformed to a rule in response to an update of the channel configuration or an update of a region configuration;
receiving a trigger for direct memory access from an input/output device; and
detecting whether the DMA checking is ongoing: ignoring the trigger until the DMA checking is completed if the DMA checking is ongoing; and initiating or denying a transfer based on a check result if the DMA checking is completed.

18. The method of claim 17, wherein:
the rule comprises a consistency of the channel configuration and the region configuration.

19. The method of claim 17, wherein:
if the channel configuration is conformed to the rule, the transfer is initiated; and if the channel configuration violates the rule, the trigger is ignored and the transfer is denied.

20. The method of claim 17, further comprising:
noticing a processor if the configuration of the applied channel violates the rule.
